(19) United States
(12) Patent Application Publication
(10) Pub. No.: US 2026/0039046 A1
(43) Pub. Date: Feb. 5, 2026

(54) CONNECTOR ASSEMBLY

(71) Applicant: ADVANCED-CONNECTEK INC., New Taipei City (TW)

(72) Inventors: Shu-Fen Wang, New Taipei City (TW); Kuan-Lin Chen, New Taipei City (TW); Hou-Bin Lin, New Taipei City (TW)

(21) Appl. No.: 19/283,784

(22) Filed: Jul. 29, 2025

(30) Foreign Application Priority Data
Aug. 2, 2024 (TW) 113129089

(51) Int. Cl. H01R 12/79; H01R 12/77

(52) U.S. Cl. CPC H01R 12/79; H01R 12/774

(57) ABSTRACT

A connector assembly includes a board-end connector and a cable-end connector. The board-end connector includes an insulated housing, flexible locking members, an outer shell, a pressing member, and a terminal module. The insulated housing has a receiving cavity. Each of two sides of the insulated housing has a recess in communication with the receiving cavity and an engaging block extending outward. The flexible locking members are engaged with the engaging blocks. The pressing member is arranged outside the outer shell to be connected to the flexible locking members. The terminal module is in the receiving cavity and includes ground terminals and several pairs of signal terminals arranged as a single row along an axial line. The cable-end connector includes a flexible parallel cable and a plug at one end of the flexible parallel cable.

### CROSS-REFERENCE TO RELATED APPLICATION

This non-provisional application claims priority under 35 U.S.C. § 119(a) to Patent Application No. 113129089 filed in Taiwan, R.O.C. on Aug. 2, 2024, the entire contents of which are hereby incorporated by reference.

### FIELD OF THE INVENTION

The instant disclosure relates to a connector, and more particular to a connector assembly.

### BACKGROUND

The connection interfaces in telecommunication industry are developed to be lightweight and tiny and to have stable signal transmissions. For the connection interfaces applied in high speed transmission server and switch, for example, the mini cool edge IO (MCIO) connector, the MCIO connector has a small size plus reliable and stable connection. An MCIO connector known to the inventor includes a board-end connector and a cable-end connector. The cable-end connector comprises a cable, a PCB, and a plug on the PCB. The plug has a plastic core, upper and lower terminals, and a hook member. The board-end connector known to the inventor has a plurality of buckling holes, the cable-end connector has pin-type buckling structures capable of being buckled with the buckling holes. However, the arrangement of the components of the buckling structures is complicated, and thus the manufacturing cost for the connector is high.

### SUMMARY OF THE INVENTION

In view of these, some embodiments of the instant disclosure provides a connector assembly comprising a board-end connector and a cable-end connector. The board-end connector comprises an insulated housing, a plurality of flexible locking members, an outer shell, a pressing member, and a terminal module. The insulated housing has a receiving cavity. One end of the insulated housing has an insertion opening in communication with the receiving cavity. Each of two sides of the insulated housing has a recess and an engaging block in the recess, and each of the recesses is in communication with the receiving cavity. Each of the flexible locking members comprises an flexible arm. Each of two ends of the flexible arm comprises a hook portion and a first buckling portion. Each of the hook portions is engaged with a corresponding one of the engaging blocks. Each of the first buckling portions is arranged in a corresponding one of the recesses and extends to the receiving cavity. The outer shell is arranged outside the insulated housing. The outer shell comprises a cover plate, and the outer shell comprises a side plate and a through portion at each of two sides of the cover plate. The pressing member is arranged outside the outer shell. The pressing member is connected to the first buckling portion of each of the flexible locking members through a corresponding one of the through portions. The terminal module is in the receiving cavity of the insulated housing. The terminal module comprises a plurality of ground terminals and a plurality of pairs of signal terminals arranged as a single row along an axial line. The cable-end connector comprises a flexible parallel cable and a plug at one end of the flexible parallel cable. Each of two sides of the plug comprises a second buckling portion. When the plug of the cable-end connector is inserted into the receiving cavity through the insertion opening, each of the second buckling portions is engaged with the first buckling portion of a corresponding one of the flexible locking members.

In some embodiments, the flexible arm comprises a horizontal section and an oblique section, the hook portion has a bent section and an engaging portion, the first buckling portion comprises a guiding arm arranged along a first axial line and a protrusion arranged along a second axial line, the bent section is connected to the horizontal section, the bent section is bent toward an inner side of the horizontal section along a third axial line, the engaging portion extends outward from the bent section along the first axial line, the oblique section is connected to the first buckling portion, and the protrusion is in the receiving cavity for being assembled with the cable-end connector.

In some embodiments, the recesses are in communication with the receiving cavity through two side surfaces of the insulated housing, each of the recesses is recessed toward the receiving cavity to form a recessed space, and each of the engaging blocks outward extends from an inner side of a corresponding one of the recesses toward a direction away from the receiving cavity.

In some embodiments, the recesses are in communication with the receiving cavity through two side surfaces of the insulated housing, each of the recesses is recessed toward the receiving cavity to form a recessed space, and each of the engaging blocks outward extends from an inner side of a corresponding one of the recesses toward a direction away from the receiving cavity.

In some embodiments, one end of the bent section is in the groove, the bent section extends outward from the groove to cover one of the two side surfaces of the engaging block, the horizontal section covers the top surface of the engaging block, the oblique section covers the other one of the two side surfaces of the engaging block, and the bent section, the horizontal section, and the oblique section surround the two side surfaces and the top surface of the engaging block.

In some embodiments, the recess forms a hollow portion at a bottom surface of the insulated housing, and the first buckling portion of each of the flexible locking members is movable in the corresponding one of the grooves along the second axial line.

In some embodiments, the guiding arm of each of the flexible locking members further comprises a side arm, each of the side arms is away from one end of a corresponding one of the protrusions, the pressing member comprises a bar body and two limiting portions at two ends of the bar body, each of the through portions is on a corresponding one of the side plates, each of the side arms protrudes out of the through portion of a corresponding one of the side plates and extends toward the corresponding one of the limiting portions along the second axial line.

In some embodiments, each of the side arms has a guiding groove away from one end of a corresponding one of the guiding arms, a middle portion of the guiding groove has an engaging region, an opening of the guiding groove has a guiding groove opening in communication with the engaging region, the guiding groove is gradually tapered from the guiding groove opening to the engaging region, and the bar body of the pressing member is fixable on the engaging region of each of the side arms.

In some embodiments, each of two sides of a top surface of the insulated housing has a through groove, each of the through grooves is in communication with a corresponding one of the recesses, the pressing member comprises a plate body and two pressing arms at two ends of the plate body, the through portions are at two sides of the cover plate, and each of the pressing arms passes through a corresponding one of the through portions of the cover plate and a corresponding one of the through grooves of the insulated housing to contact a corresponding one of the first buckling portions. In some embodiments, the pressing arm comprises a stopping portion at a side surface of the pressing arm and limited by an inner side of the cover plate.

According to some embodiments of the instant disclosure, the flexible locking members are engaged with the insulated housing, each of the flexible locking members is in communication with the receiving cavity through the corresponding one of the recesses, and each of the flexible locking members is connected to the corresponding one of the first buckling portions. When the pressing member is pressed to push the flexible locking members, each of the first buckling portions drives the corresponding one of the flexible arms to move, so that each of the second buckling portions is detached from the corresponding one of the first bucking portions. Accordingly, the engagement between the plug of the cable-end connector and the flexible locking members can be released.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a connector assembly according to some embodiments of the instant disclosure, where a board-end connector and a cable-end connector of the connector assembly are not mated with each other yet;

FIG. 2 illustrates a front exploded view of the board-end connector according to some embodiments of the instant disclosure;

FIG. 3 illustrates a rear exploded view of the board-end connector according to some embodiments of the instant disclosure;

FIG. 4 illustrates a perspective view of an flexible locking member according to some embodiments of the instant disclosure;

FIG. 5 illustrates a cross-sectional view along line A-A shown in FIG. 1, where the flexible locking member of the board-end connector and the second buckling portion of the cable-end connector are not engaged with each other yet;

FIG. 6 illustrates a cross-sectional view along line B-B shown in FIG. 1, where the flexible locking member of the board-end connector and the second buckling portion of the cable-end connector are engaged with each other;

FIG. 7 illustrates a cross-sectional view from the perspective of FIG. 6, where the engagement between the flexible locking member of the board-end connector and the second buckling portion of the cable-end connector is released;

FIG. 8 illustrates a perspective view of the connector assembly according to some embodiments of the instant disclosure, where the outer shell is not shown;

FIG. 9 illustrates a perspective view of the connector assembly according to some embodiments of the instant disclosure, where the board-end connector and the cable-end connector are not mated with each other yet;

FIG. 10 illustrates a front exploded view of the board-end connector according to some embodiments of the instant disclosure;

FIG. 11 illustrates a rear exploded view of the board-end connector according to some embodiments of the instant disclosure;

FIG. 12 illustrates a perspective view of the flexible locking member according to some embodiments of the instant disclosure;

FIG. 13 illustrates a cross-sectional view along line C-C shown in FIG. 9, where the flexible locking member of the board-end connector and the second buckling portion of the cable-end connector are engaged with each other;

FIG. 14 illustrates a cross-sectional view from the perspective of FIG. 13, where the engagement between the flexible locking member of the board-end connector and the second buckling portion of the cable-end connector is released; and

FIG. 15 illustrates perspective view of the connector assembly, where the outer shell is not shown.

### DETAILED DESCRIPTION

To illustrate the embodiments of the instant disclosure, in the drawings, the first axis X is the X axis of the Cartesian coordinate, the second axis Y is the Y axis of the Cartesian coordinate, and the third axis is the Z axis of the Cartesian coordinate.

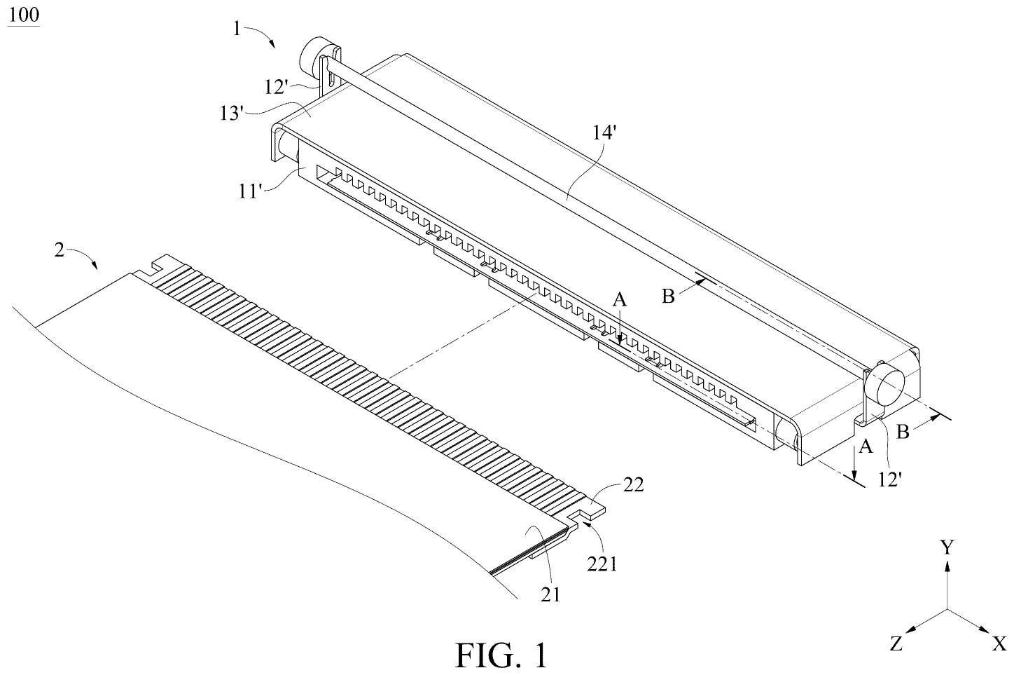

Please refer to FIG. 1. FIG. 1 illustrates a perspective view of a connector assembly 100, where a board-end connector 1 and a cable-end connector 2 of the connector assembly 100 are not mated with each other yet. The connector assembly 100 comprises a board-end connector 1 and a cable-end connector 2. The board-end connector 1 is an elongated connector; the long side of the board-end connector 1 extends along a first axis X direction, the short side of the board-end connector 1 extends along a third axis Z direction, and the height of the board-end connector extends along a second axis Y direction. The cable-end connector 2 is adapted to be applied for a flexible flat cable (FFC). Because the board-end connector 1 is adapted to be mated with the FFC type cable-end connector 2, the size of the board-end connector 1 can be reduced relatively.

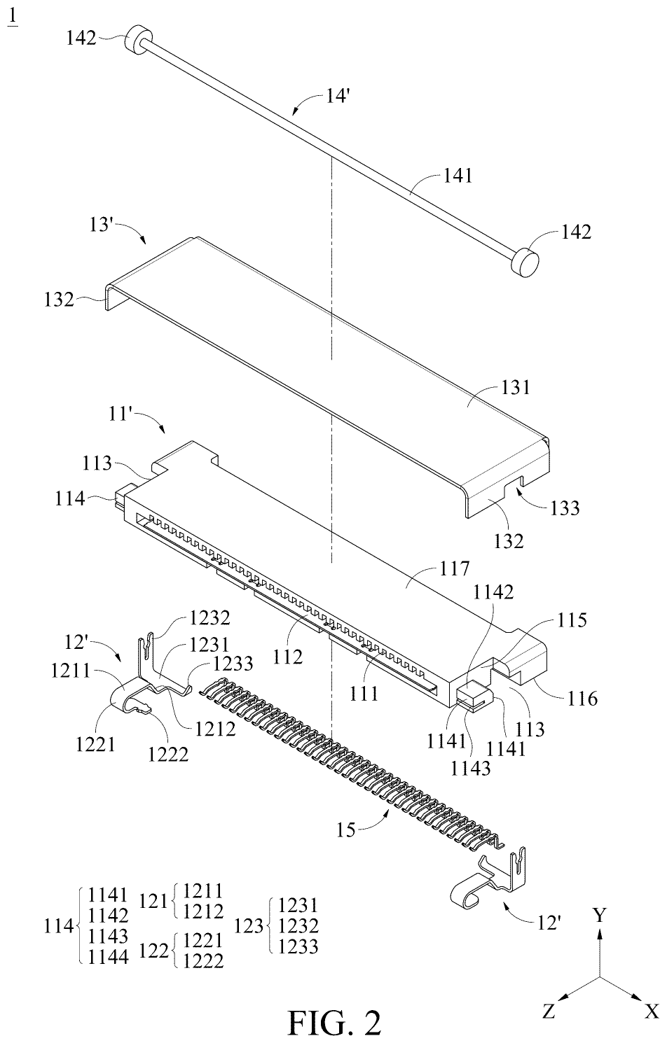

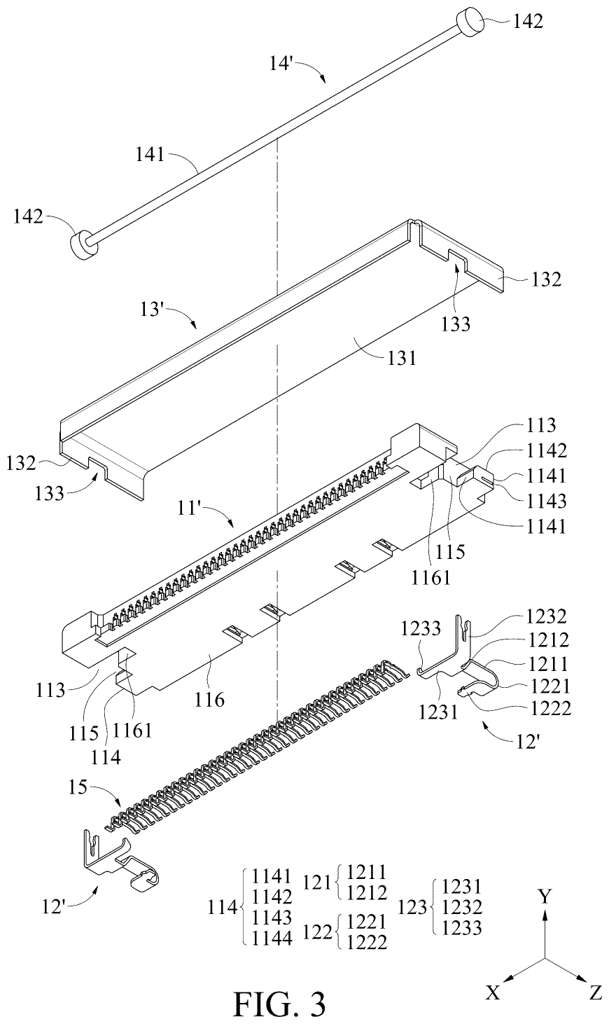

Please refer to FIG. 2 and FIG. 3. FIG. 2 illustrates a front exploded view of the board-end connector 1. FIG. 3 illustrates a rear exploded view of the board-end connector 1. The board-end connector 1 comprises an insulated housing 11′, a plurality of flexible locking members 12′, an outer shell 13′, a pressing member 14′, and a terminal module 15. The insulated housing 11′ is a hollow rectangular plastic core. The insulated housing 11′ has a receiving cavity 111, and one end of the insulated housing 11′ has an insertion opening 112 in communication with the receiving cavity 111. The receiving cavity 111 and the insertion opening 112 are together defined through the insulated housing 11′ along the third axis Z direction, and the insertion opening 112 is a long and narrow opening extending along the first axis X direction. Each of two sides of the insulated housing 11′ has a recess 113 in communication with the receiving cavity 111. The recess 113 forms a recessed space 115 toward the receiving cavity 111. An engaging block 114 is on an inner wall of the recess 113. The engaging block 114 has two side surfaces 1141 and a top surface 1142 connected between the two side surfaces 1141. One of the two side surfaces 1141 of the engaging block 114 has a groove 1143 recessed along the third axis Z direction, at one of the two sides surfaces 1141. Each of two sides of a bottom surface 116 of the insulated housing 11′ has a hollow portion 1161, and each of the hollow portions 1161 is in communication with a corresponding one of the recesses 113.

The outer shell 13′ is a metallic shield. The outer shell 13′ comprises a cover plate 131, and the outer shell 13′ comprises a side plate 132 and a through portion 133 at each of two sides of the cover plate 131. The side plates 132 are bent from the cover plate 131. The insulated housing 11′ and the flexible locking members 12′ are arranged at an inner side of the cover plate 131.

The pressing member 14′ is arranged outside the outer shell 13′, and the pressing member 14′ is connected to the first buckling portion 123 of each of the flexible locking members 12′ through a corresponding one of the through portions 133.

The terminal module 15 is in the receiving cavity 111 of the insulated housing 11′, and the terminal module 15 comprises a plurality of ground terminals and a plurality of pairs of signal terminals arranged as a single row along an axial line.

Please refer to FIG. 1 to FIG. 3. The cable-end connector 2 comprises a flexible parallel cable 21 and a plug 22 at one end of the flexible parallel cable 21. Each of two sides of the plug 22 comprises a second buckling portion 221. In some embodiments, the flexible parallel cable 21 is a flexible flat cable (FFC), the length of the flexible parallel cable 21 is not limited, the plug 22 is an elongated plate, and two plugs 22 are at two ends of the flexible parallel cable 21, respectively.

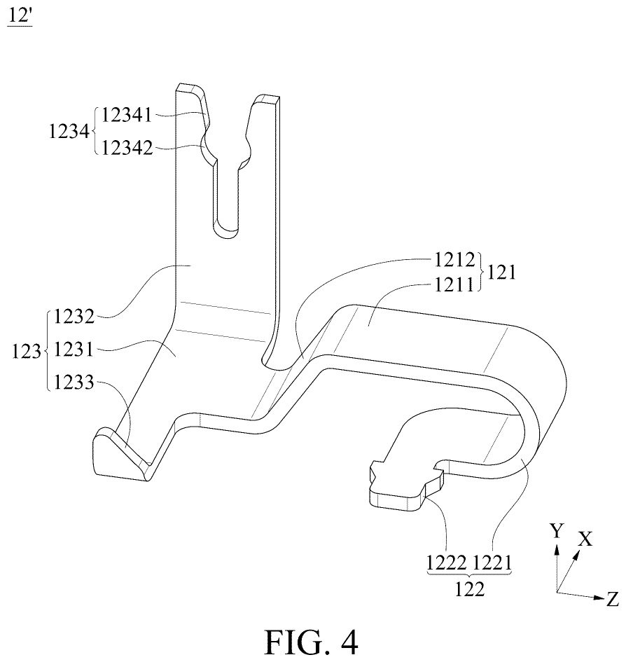

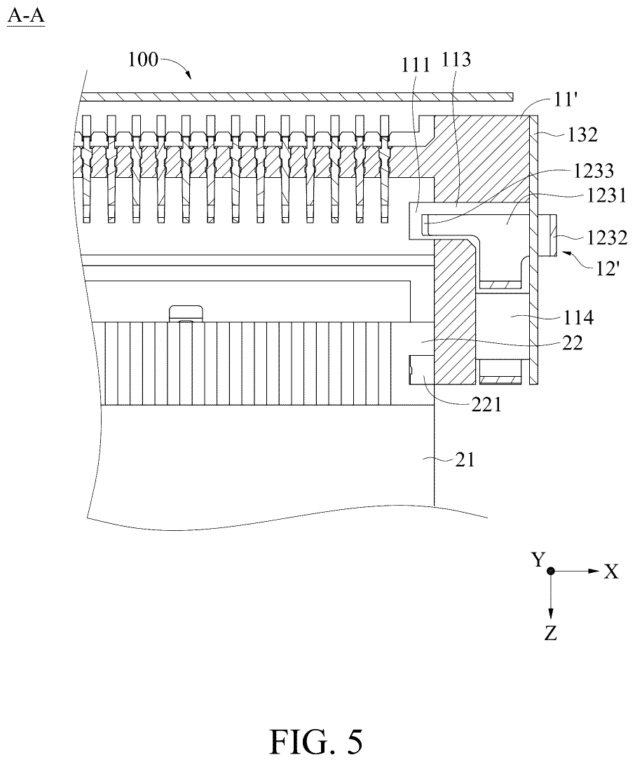

Please refer to FIG. 4 and FIG. 5. FIG. 4 illustrates a perspective view of an flexible locking member 12′. FIG. 5 illustrates a cross-sectional view along line A-A shown in FIG. 1, where the flexible locking member 12′ of the board-end connector 1 and the second buckling portion 221 of the cable-end connector 2 are not engaged with each other yet. In some embodiments, the flexible locking member 12′ has a side arm 1232 at a side portion of the guiding arm 1231, the side arm 1232 is at one end of the guiding arm 1231 away from the protrusion 1233, the side arm 1232 extends toward the top surface 131 of the outer shell 13′ along the second axis Y direction (the second axial line), the side arm 1232 has a guiding groove 1234 arranged along the second axis Y direction, a middle portion of the guiding groove 1234 has an engaging region 12342, an opening of the guiding groove 1234 has a guiding groove opening 12341 in communication with the engaging region 12342, and the guiding groove 1234 is gradually tapered from the guiding groove opening 12341 to the engaging region 12342.

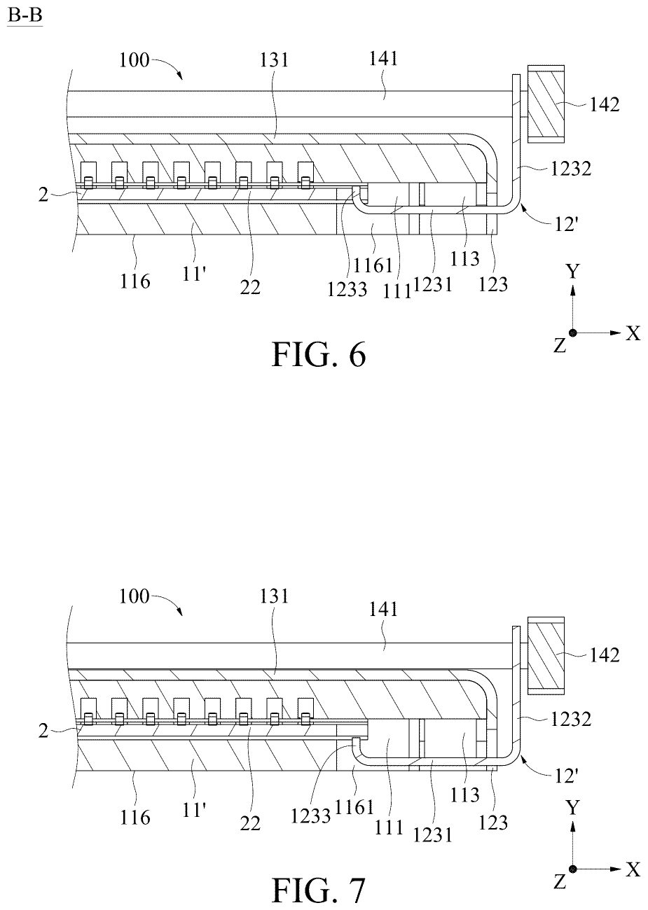

Please refer to FIG. 5 and FIG. 6. FIG. 6 illustrates a cross-sectional view along line B-B shown in FIG. 1, where the flexible locking member 12′ of the board-end connector 1 and the second buckling portion 221 of the cable-end connector 2 are engaged with each other. When the plug 22 of the cable-end connector 2 is inserted into the receiving cavity 111 through the insertion opening 112, each of the second buckling portions 221 is engaged with a corresponding one of the flexible locking members 12′. When the pressing member 14′ pushes the first buckling portion 123 of each of the flexible locking members 12′, each of the second buckling portions 221 is detached from the first bucking portion 123 of the corresponding one of the flexible locking members 12′. Specifically, in some embodiments, the recesses 113 are in communication with the receiving cavity 111 of the insulated housing 11′ and each of the flexible locking members 12′ is in a corresponding one of the recesses 113. Therefore, when the cable-end connector 2 is mated with the board-end connector 1, the plug 22 of the cable-end connector 2 is inserted into the receiving cavity 111 through the insertion opening 112, and each of the second buckling portions 221 is engaged with the first buckling portion 123 of the corresponding one of the flexible locking members 12′ in the receiving cavity 111. When the pressing member 14′ pushes the flexible locking members 12′, the first buckling portion 123 of each of the flexible locking members 12′ is detached from the corresponding one of the second buckling portions 221, so that the cable-end connector 2 can be pulled out easily, and thus the cable-end connector 2 can be detached from the board-end connector 1.

In some embodiments, each of the flexible locking members 12′ is a metallic clip, the flexible arm 121 comprises a horizontal section 1211 and an oblique section 1212. Each of two ends of the flexible arm 121 comprises a hook portion 122 and a first buckling portion 123; as shown in FIG. 5, the first buckling portion 122 of the flexible locking member 12′ can be moved in the recess 113 along the second axis Y direction (the second axial line). The hook portion 122 has a bent section 1221 and an engaging portion 1222. The first buckling portion 123 comprises a guiding arm 1231 arranged along the first axis X direction (the first axial line) and a protrusion 1233 arranged along the second axis Y direction (the second axial line). The bent section 1221 is connected to the horizontal section 1211, the bent section 1221 is bent toward an inner side of the horizontal section 1211 along the third axis Z direction, and the engaging portion 1222 extends outward from the bent section 1221 along the first axis X direction (the first axial line). The oblique section 1212 is connected to the first buckling portion 123, and the protrusion 1233 is in the receiving cavity 111 for being assembled with the cable-end connector 2. One end of the bent section 1221 away from the horizontal section 1211 is in the groove 1143, the bent section 1221 extends outward from the groove to cover one of the two side surfaces 1141 of the engaging block 114, the horizontal section 1211 covers the top surface 1142 of the engaging block 114, and the oblique section 1212 covers the other one of the two side surfaces 1141 of the engaging block 114. The bent section 1221, the horizontal section 1211, and the oblique section 1212 surround the two sides surfaces 1141 and the top surface 1142 of the engaging block 114.

Each of the flexible locking members 12′ is in a corresponding one of the recesses 113 at the two sides of the insulated housing 11′, and the protrusion 1233 of each of the flexible locking members 12′ in arranged in the receiving cavity 111 through the corresponding one of the recesses 113. When the plug 22 of the cable-end connector 2 is inserted into the receiving cavity 111 through the insertion opening 112, each of the second buckling portions 221 is engaged with the first buckling portion 123 of the corresponding one of the flexible locking members 12′.

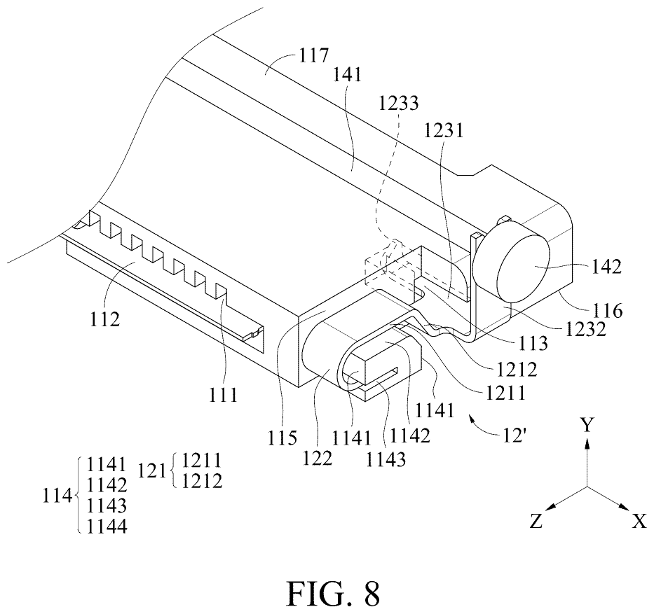

Please refer to FIG. 2, FIG. 6, FIG. 7, and FIG. 8. FIG. 7 illustrates a cross-sectional view from the perspective of FIG. 6, where the engagement between the flexible locking member 12′ of the board-end connector 1 and the second buckling portion 221 of the cable-end connector 2 is released. FIG. 8 illustrates a perspective view of the connector assembly 100, where the outer shell 13′ is not shown. In some embodiments, the pressing member 14′ comprises a bar body 141 and two limiting portions 142, and the two limiting portions 142 are at two sides of the bar body 141. Each of the through portions 133 is on a corresponding one of the side plates 132, the through portions 133 are notches on the side plates 132, and the side arm 1232 of each of the flexible locking members 12′ passes through the through portion 133 and protrudes out of the corresponding one of the side plates 132 so as to be connected to the pressing member 14′. The bar body 141 of the pressing member 14′ is assembled in the guiding groove 1234 through the guiding groove opening 12341, and the bar body 141 is engaged with the engaging region 12342. The two limiting portions 142 of the pressing member 14′ are engaged at an outer side of the two side arms 1232 to limit the range of the movement of the bar body 141 along the first axis X direction and to fix the bar body 141 to be connected to the engaging region 12342. Therefore, when the pressing member 14′ is pressed along the second axis Y direction and thus pushes the flexible locking members 12′, the flexible arm 121 of each of the flexible locking members 12′ swings along the second axis Y direction by taking a corresponding one of the hook portions 122 as an axis, so that the guiding arm 1231 of each of the flexible locking members 12′ is pushed to move along the second axis Y direction, thereby allowing the protrusion 1233 to be detached from the second buckling portion 221.

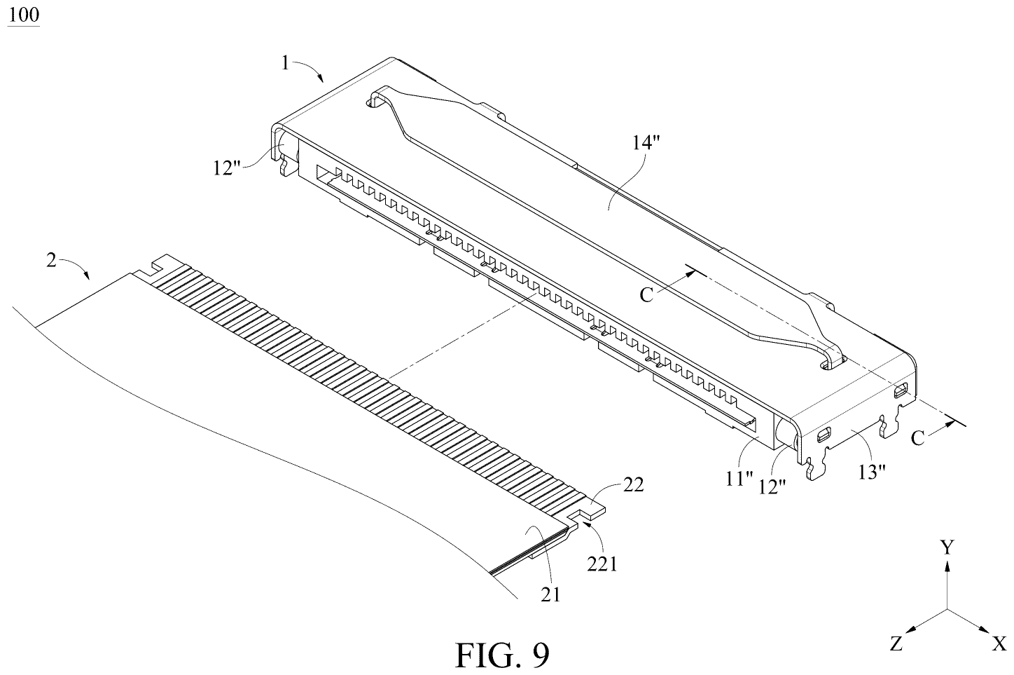

Please refer to FIG. 9. FIG. 9 illustrates a perspective view of the connector assembly 100, where the board-end connector 1 and the cable-end connector 2 are not mated with each other yet. In some embodiments, the connector assembly 100 comprises a board-end connector 1 and a cable-end connector 2. The board-end connector 1 is an elongated connector; the long side of the board-end connector 1 extends along a first axis X direction, the short side of the board-end connector 1 extends along a third axis Z direction, and the height of the board-end connector extends along a second axis Y direction.

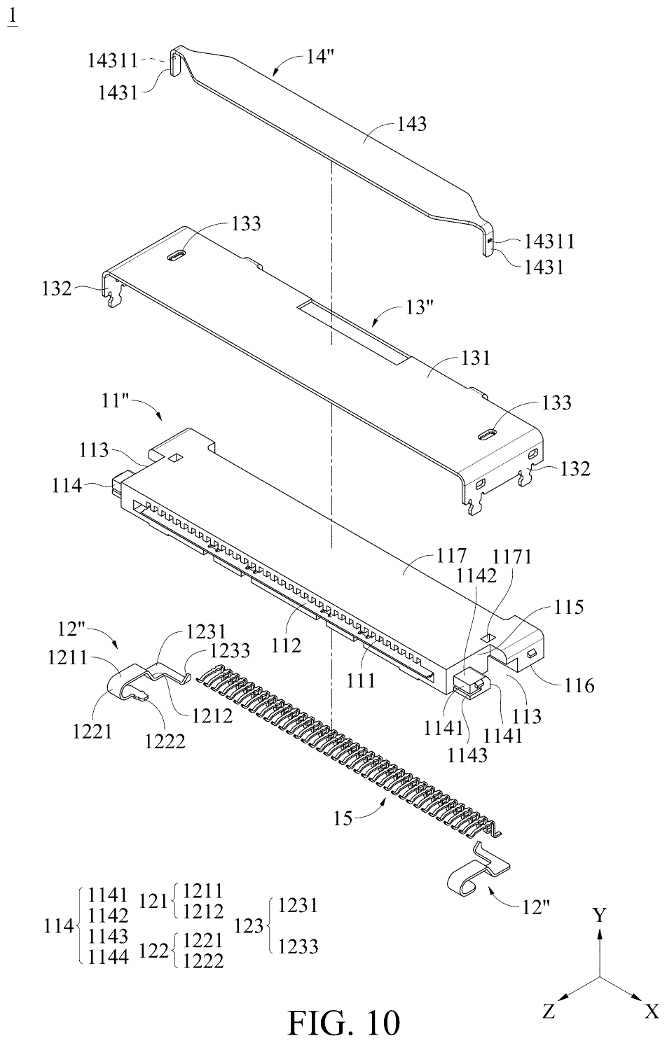

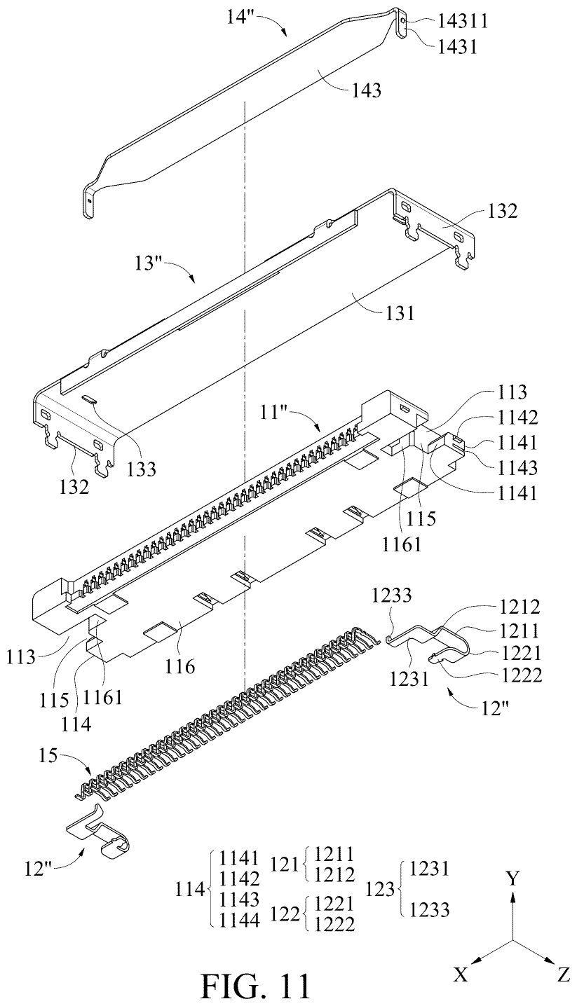

Please refer to FIG. 10 and FIG. 11. FIG. 10 illustrates a front exploded view of the board-end connector 1. FIG. 11 illustrates a rear exploded view of the board-end connector 1. In some embodiments, the board-end connector 1 comprises an insulated housing 11″, a plurality of flexible locking members 12″, an outer shell 13″, a pressing member 14″, and a terminal module 15. The insulated housing 11″ is a hollow rectangular plastic core. The insulated housing 11″ has a receiving cavity 111, and one end of the insulated housing 11″ has an insertion opening 112 in communication with the receiving cavity 111. The receiving cavity 111 and the insertion opening 112 are together defined through the insulated housing 11″ along the third axis Z direction, and the insertion opening 112 is a long and narrow opening extending along the first axis X direction. Each of two sides of the insulated housing 11″ has a recess 113 in communication with the receiving cavity 111. The recess 113 forms a recessed space 115 toward the receiving cavity 111. An engaging block 114 is on an inner wall of the recess 113. The engaging block 114 has two side surfaces 1141 and a top surface 1142 connected between the two side surfaces 1141. One of the two side surfaces 1141 of the engaging block 114 has a groove 1143 recessed along the third axis Z direction, at one of the two sides surfaces 1141. Each of two sides of a bottom surface 116 of the insulated housing 11″ has a hollow portion 1161, and each of the hollow portions 1161 is in communication with a corresponding one of the recesses 113. The difference between the insulated housing 11″ of this embodiment and the insulated housing 11″ of the foregoing embodiment lies in that, in this embodiment, each of two sides of a top surface 117 of the insulated housing 11″ has a through groove 1171, and each of the through grooves 1171 is in communication with a corresponding one of the recesses 113.

The outer shell 13″ is a metallic shield. The outer shell 13″ comprises a cover plate 131, and the outer shell 13″ comprises a side plate 132 and a through portion 133 at each of two sides of the cover plate 131. The side plates 132 are bent from the cover plate 131. The insulated housing 11″ and the flexible locking members 12′ are arranged at an inner side of the cover plate 131. The difference between the outer shell 13″ of this embodiment and the outer shell 13′ of the foregoing embodiment lies in that, in this embodiment, the outer shell 13″ comprises the through portion 133 at each of two sides of the cover plate 131, and the through portions 133 are defined through the surfaces at the two sides of the cover plate 131.

The pressing member 14″ is arranged outside the outer shell 13″, the pressing member 14″ comprises a plate body 143 and two pressing arms 1431 at two ends of the plate body 143, and the pressing member 14″ is connected to the first buckling portion 123 of each of the flexible locking members 12″ through a corresponding one of the through portions 133. The difference between the pressing member 14″ of this embodiment and the pressing member 14′ of the foregoing embodiment lies in that, in this embodiment, the plate body 143 is flat, and each of the pressing arms 1431 passes through a corresponding one of the through portions 133 of the cover plate 131 and passes through a corresponding one of the through grooves 1171 of the insulated housing 11″ to contact the corresponding one of the first buckling portions 123.

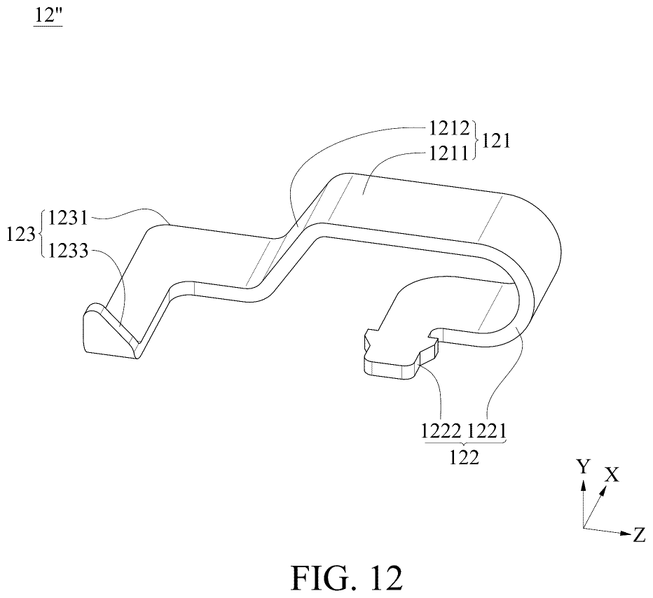

Please refer to FIG. 12. FIG. 12 illustrates a perspective view of the flexible locking member 12″. In some embodiments, the difference between the flexible locking member 12″ of this embodiment and the flexible locking member 12′ of the foregoing embodiment lies in that, in this embodiment, one end of the guiding arm 1231 of the flexible locking member 12″ away from the protrusion 1233 does not include the side arm 1232 mentioned in the foregoing embodiment.

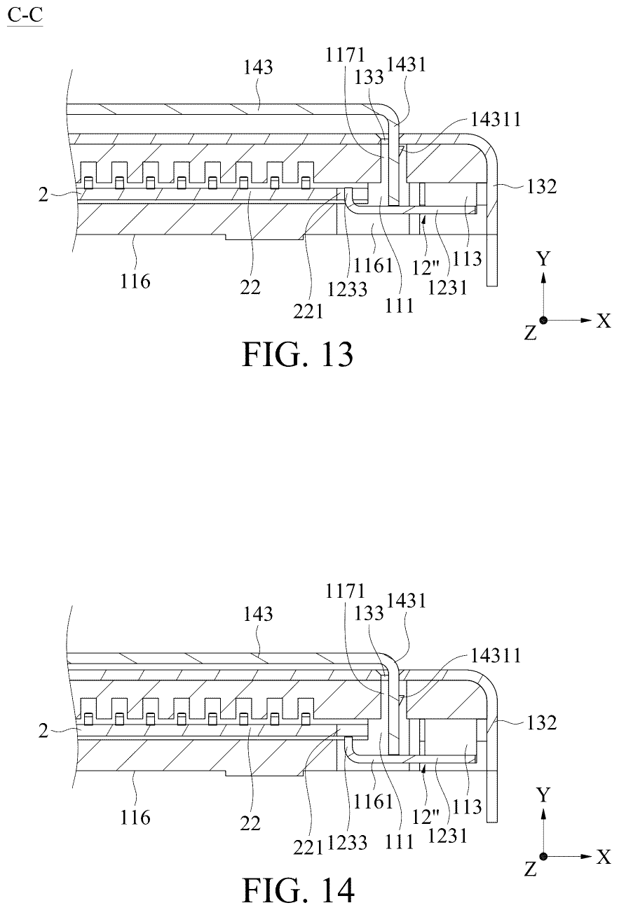

Please refer to FIG. 13 and FIG. 14. FIG. 13 illustrates a cross-sectional view along line C-C shown in FIG. 9, where the flexible locking member 12″ of the board-end connector 1 and the second buckling portion 221 of the cable-end connector 2 are engaged with each other. When the plug 22 of the cable-end connector 2 is inserted into the receiving cavity 111 through the insertion opening 112, each of the second buckling portions 221 is engaged with a corresponding one of the flexible locking members 12″. When the pressing member 14″ pushes the first buckling portion 123 of each of the flexible locking members 12″, each of the second buckling portions 221 is detached from the first bucking portion 123 of the corresponding one of the flexible locking members 12″. Specifically, in some embodiments, the recesses 113 are in communication with the receiving cavity 111 of the insulated housing 11″ and each of the flexible locking members 12″ is in a corresponding one of the recesses 113. Therefore, when the cable-end connector 2 is mated with the board-end connector 1, the plug 22 of the cable-end connector 2 is inserted into the receiving cavity 111 through the insertion opening 112, and each of the second buckling portions 221 is engaged with the first buckling portion 123 of the corresponding one of the flexible locking members 12′ in the receiving cavity 111. When the pressing member 14″ pushes the flexible locking members 12″, the first buckling portion 123 of each of the flexible locking members 12″ is detached from the corresponding one of the second buckling portions 221, so that the cable-end connector 2 can be pulled out easily, and thus the cable-end connector 2 can be detached from the board-end connector 1.

In some embodiments, each of the flexible locking members 12′ is a metallic clip, and the configuration between the flexible locking members 12″ and the insulated housing 13″ of this embodiment is the same as the configuration between the flexible locking members 12′ and the insulated housing 13′ of the foregoing embodiment.

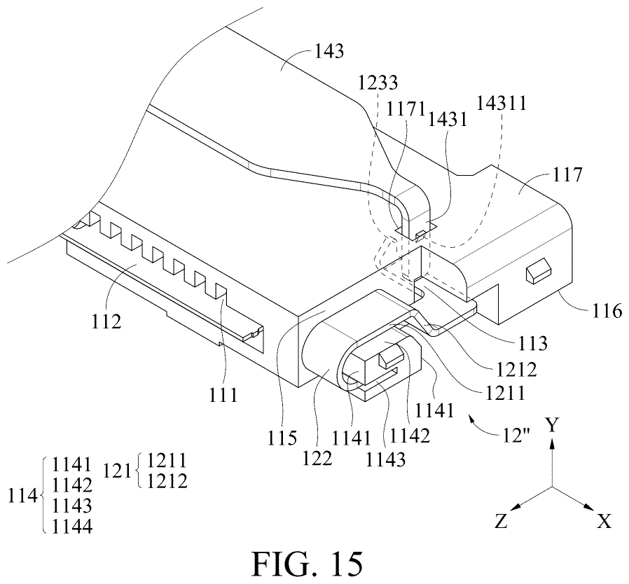

Please refer to FIG. 10, FIG. 13, FIG. 14, and FIG. 15. FIG. 14 illustrates a cross-sectional view from the perspective of FIG. 13, where the engagement between the flexible locking member 12″ of the board-end connector 1 and the second buckling portion 221 of the cable-end connector 2 is released. FIG. 15 illustrates perspective view of the connector assembly 100, where the outer shell 133″ is not shown. In some embodiments, the pressing arm 1431 comprises a stopping portion 14311 at a side surface of the pressing arm 1431 and limited by an inner side of the cover plate 131. Specifically, in some embodiments, the stopping portion 14311 is arranged on the side surface of the pressing arm 1431, each of the flexible locking members 12″ flexibly limits the stopping portion 1433 at the inner side of the cover plate 131, so that the pressing member 14″ continuously contacts the flexible locking members 12″. Therefore, when the pressing member 14″ pushes the flexible locking members 12″, the flexible arm 121 of each of the flexible locking members 12″ swings along the second axis Y direction by taking a corresponding one of the hook portions 122 as an axis, so that the guiding arm 1231 swings to the hollow portion 1161, thereby allowing the protrusion 1233 to be detached from the second buckling portion 221.

According to some embodiments of the instant disclosure, the flexible locking members are engaged with the insulated housing, each of the flexible locking members is in communication with the receiving cavity through the corresponding one of the recesses, and each of the flexible locking members is connected to the corresponding one of the first buckling portions. When the pressing member is pressed to push the flexible locking members, each of the first buckling portions drives the corresponding one of the flexible arms to move, so that each of the second buckling portions is detached from the corresponding one of the first bucking portions. Accordingly, the engagement between the plug of the cable-end connector and the flexible locking members can be released.

While the instant disclosure has been described by the way of example and in terms

of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A connector assembly, comprising:
a board-end connector comprising:
an insulated housing having a receiving cavity, wherein one end of the insulated housing has an insertion opening in communication with the receiving cavity, each of two sides of the insulated housing has a recess and an engaging block in the recess, and each of the recesses is in communication with the receiving cavity;
a plurality of flexible locking members, wherein each of the flexible locking members comprises an flexible arm, each of two ends of the flexible arm comprises a hook portion and a first buckling portion, each of the hook portions is engaged with a corresponding one of the engaging blocks, each of the first buckling portions is arranged in a corresponding one of the recesses and extends to the receiving cavity;
an outer shell arranged outside the insulated housing, wherein the outer shell comprises a cover plate, and the outer shell comprises a side plate and a through portion at each of two sides of the cover plate;
a pressing member arranged outside the outer shell, wherein the pressing member is connected to the first buckling portion of each of the flexible locking members through a corresponding one of the through portions; and
a terminal module in the receiving cavity of the insulated housing, wherein the terminal module comprises a plurality of ground terminals and a plurality of pairs of signal terminals arranged as a single row along an axial line; and
a cable-end connector comprising a flexible parallel cable and a plug at one end of the flexible parallel cable, wherein each of two sides of the plug comprises a second buckling portion;
wherein when the plug of the cable-end connector is inserted into the receiving cavity through the insertion opening, each of the second buckling portions is engaged with the first buckling portion of a corresponding one of the flexible locking members; when the pressing member pushes the first buckling portion of each of the flexible locking members, each of the second buckling portions is detached from the first bucking portion of the corresponding one of the flexible locking members.

2. The connector assembly according to claim 1, wherein the flexible arm comprises a horizontal section and an oblique section, the hook portion has a bent section and an engaging portion, the first buckling portion comprises a guiding arm arranged along a first axial line and a protrusion arranged along a second axial line, the bent section is connected to the horizontal section, the bent section is bent toward an inner side of the horizontal section along a third axial line, the engaging portion extends outward from the bent section along the first axial line, the oblique section is connected to the first buckling portion, and the protrusion is in the receiving cavity for being assembled with the cable-end connector.

3. The connector assembly according to claim 2, wherein the recesses are in communication with the receiving cavity through two side surfaces of the insulated housing, each of the recesses is recessed toward the receiving cavity to form a recessed space, and each of the engaging blocks outward extends from an inner side of a corresponding one of the recesses toward a direction away from the receiving cavity.

4. The connector assembly according to claim 3, wherein the engaging block has two side surfaces and a top surface connected between the two side surfaces, one of the two side surfaces of the engaging block has a groove, and the engaging portion is in the groove.

5. The connector assembly according to claim 4, wherein one end of the bent section is in the groove, the bent section extends outward from the groove to cover one of the two side surfaces of the engaging block, the horizontal section covers the top surface of the engaging block, the oblique section covers the other one of the two side surfaces of the engaging block, and the bent section, the horizontal section, and the oblique section surround the two side surfaces and the top surface of the engaging block.

6. The connector assembly according to claim 2, wherein the recess forms a hollow portion at a bottom surface of the insulated housing, and the first buckling portion of each of the flexible locking members is movable in the corresponding one of the grooves along the second axial line.

7. The connector assembly according to claim 2, wherein the guiding arm of each of the flexible locking members further comprises a side arm, each of the side arms is away from one end of a corresponding one of the protrusions, the pressing member comprises a bar body and two limiting portions at two ends of the bar body, each of the through portions is on a corresponding one of the side plates, each of the side arms protrudes out of the through portion of a corresponding one of the side plates and extends toward the corresponding one of the limiting portions along the second axial line.

8. The connector assembly according to claim 7, wherein each of the side arms has a guiding groove away from one end of a corresponding one of the guiding arms, a middle portion of the guiding groove has an engaging region, an opening of the guiding groove has a guiding groove opening in communication with the engaging region, the guiding groove is gradually tapered from the guiding groove opening to the engaging region, and the bar body of the pressing member is fixable on the engaging region of each of the side arms.

9. The connector assembly according to claim 1, wherein each of two sides of a top surface of the insulated housing has a through groove, each of the through grooves is in communication with a corresponding one of the recesses, the pressing member comprises a plate body and two pressing arms at two ends of the plate body, the through portions are at two sides of the cover plate, and each of the pressing arms passes through a corresponding one of the through portions of the cover plate and a corresponding one of the through grooves of the insulated housing to contact a corresponding one of the first buckling portions.

10. The connector assembly according to claim 9, wherein the pressing arm comprises a stopping portion at a side surface of the pressing arm and limited by an inner side of the cover plate.
